(19) United States
(12) Patent Application Publication
(10) Pub. No.: US 2026/0245583 A1
(43) Pub. Date: Aug. 20, 2026

(54) DISK DEVICE

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventors: Hirofumi NESORI, Ota Tokyo (JP); Hisashi HASEGAWA, Yokohama Kanagawa (JP); Kenichiro AOKI, Machida Tokyo (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/324,439

(22) Filed: Sep. 10, 2025

(30) Foreign Application Priority Data
Feb. 18, 2025 (JP) 2025-024057

(51) Int. Cl. G11B 5/48

(52) U.S. Cl. CPC G11B 5/4833

(57) ABSTRACT

According to one embodiment, a disk device includes a first base plate, a second base plate, and a carriage. The carriage includes an arm located between the first base plate and the second base plate. The arm is provided with a first through-hole and includes an inner surface defining the first through-hole. The first base plate includes first protrusions in contact with the inner surface. The second base plate includes second protrusions in contact with the inner surface. The first protrusions are disposed such that at least one of the second protrusions is located between two adjacent first protrusions. The second protrusions are disposed such that at least one of the first protrusions is located between two adjacent second protrusions. The first base plate and the second base plate are attached to each other by mutual contact between the first protrusions and the second protrusions.

### CROSS-REFERENCE TO RELATED APPLICATIONS

This application is based upon and claims the benefit of priority from Japanese Patent Application No. 2025-024057, filed on Feb. 18, 2025; the entire contents of which are incorporated herein by reference.

### FIELD

Embodiments described herein relate generally to disk devices.

### BACKGROUND

A disk device such as a hard disk drive (HDD) typically includes, for example, magnetic disks and a head stack assembly (HSA). The HSA includes a rotatable carriage and head gimbal assemblies (HGA) attached to arms of the carriage.

Each HGA includes, for example, a base plate, a load beam extending from the base plate, a flexure attached to the load beam, and a magnetic head mounted on the flexure. The base plate has a boss fitted into a through-hole formed in the arm. The through-hole is defined by the inner surface of the arm. By the contact between the boss and the inner surface of the arm, the base plate is attached to the arm. The carriage includes a plurality of arms each of which has two base plates attached thereto.

For example, in the case of the arms of a smaller thickness, the through-holes therein may decrease in depth, which results in limiting the contact area between each of the two bosses fitted into the through-holes and the inner surface of each arm. Such a limitation may weaken the joint between at least one of the bosses and the inner surface of the arm.

### BRIEF DESCRIPTION OF THE DRAWINGS

FIG. 1 is an exemplary exploded perspective view illustrating an HDD according to a first embodiment;

FIG. 2 is an exemplary cross-sectional view illustrating a portion of the HDD according to the first embodiment;

FIG. 3 is an exemplary plan view partially illustrating an HGA and an arm according to the first embodiment;

FIG. 4 is an exemplary cross-sectional view partially illustrating two HGAs and an arm according to the first embodiment along line F4-F4 in FIG. 3;

FIG. 5 is an exemplary cross-sectional view partially illustrating the arm and two base plates according to the first embodiment along line F5-F5 in FIG. 4;

FIG. 6 is an exemplary cross-sectional view partially illustrating an arm and two base plates according to a second embodiment; and

FIG. 7 is an exemplary cross-sectional view partially illustrating an arm and two base plates according to a third embodiment.

### DETAILED DESCRIPTION

In general, according to one embodiment, a disk drive includes a plurality of magnetic disks, a head gimbal assembly, a second base plate, and a carriage. The head gimbal assembly includes a magnetic head and a first base plate, the magnetic head being configured to read and write information from and to one of the plurality of magnetic disks. The carriage is rotatable and includes an arm located between the first base plate and the second base plate. The arm is provided with a first through-hole and includes an inner surface defining the first through-hole. The first base plate includes a first surface facing the arm, and a plurality of first protrusions protruding from the first surface, each of which is attached to the arm by contact with the inner surface of the arm. The second base plate includes a second surface facing the arm, and a plurality of second protrusions protruding from the second surface, each of which is attached to the arm by contact with the inner surface of the arm. The plurality of first protrusions are disposed such that at least one of the plurality of second protrusions is located between two adjacent first protrusions of the plurality of first protrusions. The plurality of second protrusions are disposed such that at least one of the plurality of first protrusions is located between two adjacent second protrusions of the plurality of second protrusions. The first base plate and the second base plate are attached to each other by mutual contact between the plurality of first protrusions and the plurality of second protrusions. cl First Embodiment

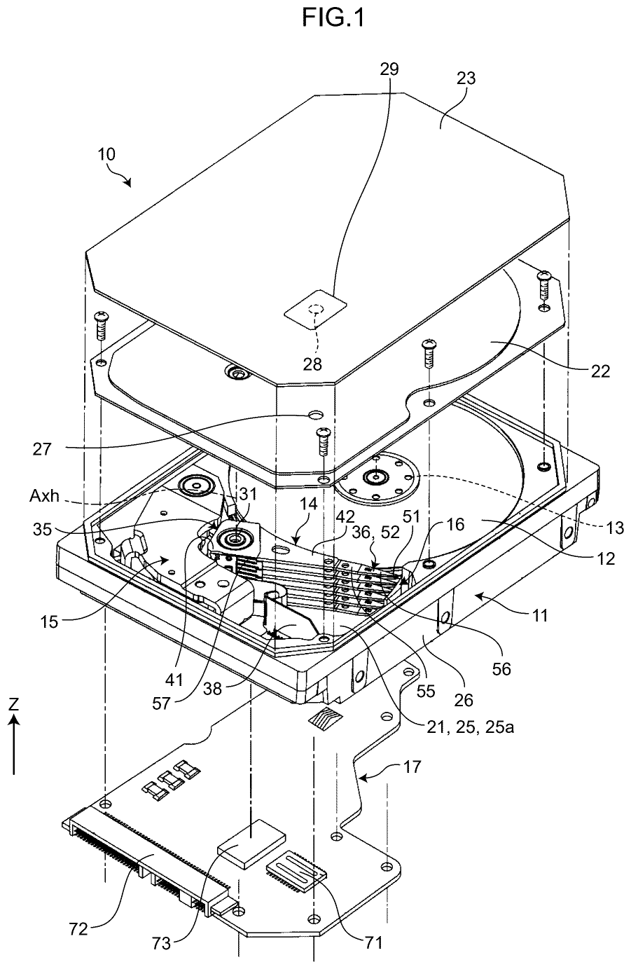

A first embodiment is described below with reference to FIGS. 1 to 5. Note that, herein, components and their descriptions according to the embodiments can be described using various expressions. The components and their descriptions are merely examples and are not limited to the specific terminology used herein. The components can be specified using names different from those used herein. Additionally, the components can also be described using expressions different from those herein.

In the following description, “suppress” is defined as, for example, preventing the occurrence of an event, action, or effect, or reducing the degree of an event, action, or effect.

FIG. 1 is an exemplary exploded perspective view illustrating a hard disk drive (HDD) 10 according to the first embodiment. The HDD 10 is an example of a disk device, and may also be referred to as an electronic device, storage device, auxiliary storage device, or magnetic disk drive.

As illustrated in FIG. 1, the HDD 10 has an enclosure 11, a plurality of magnetic disks 12, a spindle motor 13, a head stack assembly (HSA) 14, a voice coil motor (VCM) 15, a ramp load mechanism 16, and a printed circuit board (PCB) 17. The magnetic disk 12 can also be referred to as a disk or a platter.

As illustrated in FIG. 1, for convenience of description, a Z-axis and a Z-direction are defined herein. The Z-axis is set along the thickness of the HDD 10. The Z-direction is a direction along the Z-axis, and includes a +Z-direction indicated by an arrow on the Z-axis, and a-Z-direction opposite to the arrow on the Z-axis.

The enclosure 11 houses a plurality of magnetic disks 12, a spindle motor 13, an HSA 14, a VCM 15, and a ramp load mechanism 16. The enclosure 11 includes a base 21, an inner cover 22, and an outer cover 23. It is noted that the enclosure 11 is not limited to the configuration of this example.

The base 21 has a substantially rectangular box shape that is open toward the +Z-direction. The base 21 has a bottom wall 25 and side walls 26. The bottom wall 25 has a substantially rectangular (quadrilateral) plate-like shape that extends in a direction substantially orthogonal to the Z-direction. The bottom wall 25 has a bottom surface 25a facing substantially in the +Z-direction. The side wall 26 protrudes from the edge of the bottom wall 25 substantially in the +Z-direction and has a substantially rectangular frame shape.

The inner cover 22 is attached to an end portion of the side wall 26 in the +Z-direction, for example, using screws, and closes the opening of the base 21. The outer cover 23 covers the inner cover 22 and is attached to an end portion of the side wall 26 in the +Z-direction, for example, by welding.

The inner cover 22 is provided with an air vent 27. Furthermore, the outer cover 23 is provided with an air vent 28. After components are attached inside the base 21 and the inner and outer covers 22 and 23 are attached to the base 21, air within the enclosure 11 is evacuated through the air vents 27 and 28. Subsequently, the interior of the enclosure 11 is filled with a gas other than air.

The gas filled into the interior of the enclosure 11 is, for example, a low-density gas with a density lower than that of air, or an inert gas with low reactivity. For example, helium is filled into the interior of the enclosure 11. It is noted that other fluids can be filled into the interior of the enclosure 11.

The air vent 28 of the outer cover 23 is sealed with a seal 29. The seal 29 hermetically seals the air vent 28 to restrict the fluid filled in the enclosure 11 from leaking to the outside through the air vent 28.

The HDD 10 of the present embodiment includes, for example, twelve or more magnetic disks 12. However, the HDD 10 can include fewer than twelve magnetic disks 12. The plurality of magnetic disks 12 are arranged to be orthogonal to the Z-direction. The plurality of magnetic disks 12 are arranged with intervals in the Z-direction. Both surfaces of the magnetic disk 12 are provided with a magnetic recording layer.

The spindle motor 13 supports the plurality of magnetic disks 12. The plurality of magnetic disks 12 are held on a hub of the spindle motor 13 by, for example, a clamp spring. The spindle motor 13 rotates the magnetic disks 12 integrally.

The enclosure 11 further includes a support shaft 31, which is spaced apart from the magnetic disks 12. The support shaft 31 protrudes, for example, from the bottom surface 25a of the bottom wall 25 substantially in the +Z-direction. The HSA 14 is rotatably supported by the support shaft 31.

The HSA 14 is rotatable about an axis Axh. The axis Axh is a virtual axis extending substantially in the Z-direction. The axis Axh is, for example, the center of rotation of the HSA 14 and is also the axis of the support shaft 31.

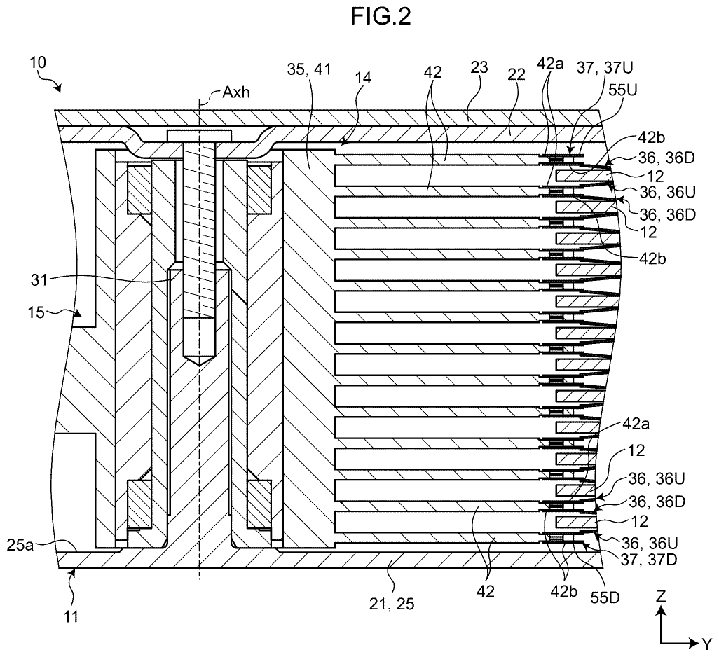

FIG. 2 is an exemplary cross-sectional view illustrating a portion of the HDD 10 according to the first embodiment. As illustrated in FIG. 2, the HSA 14 includes a carriage 35, a plurality of head gimbal assemblies (HGAs) 36, and two dummy masses 37. As illustrated in FIG. 1, the HSA 14 further includes a flexible printed circuit board (FPC) 38. The carriage 35 includes an actuator block 41 and a plurality of arms 42.

The actuator block 41 and the plurality of arms 42 are integrally formed, for example, from an aluminum alloy. It is noted that the material of the actuator block 41 and the arms 42 is not limited to this example.

The actuator block 41 is rotatably attached to the support shaft 31 via a bearing, for example, to rotate about the axis Axh. As a result, the carriage 35 is rotatable relative to the enclosure 11 around the axis Axh of the support shaft 31.

As illustrated in FIG. 2, the plurality of arms 42 protrude from the actuator block 41 in a direction substantially orthogonal to the axis Axh. Note that the HSA 14 can be divided such that the arms 42 protrude from the respective actuator blocks 41.

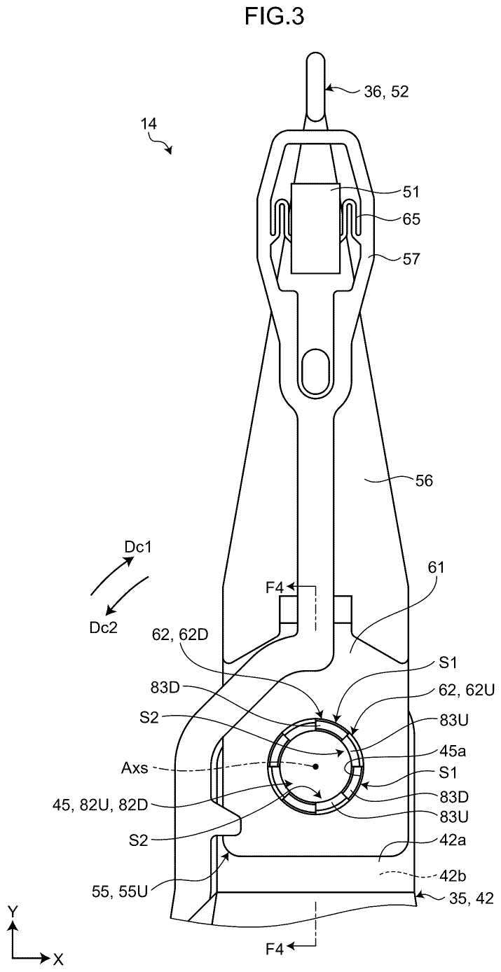

FIG. 3 is an exemplary plan view partially illustrating an HGA 36 and an arm 42 according to the first embodiment. As illustrated in FIG. 3, for convenience of description herein, X-axis and Y-axis are further defined. The X-axis, the Y-axis, and the Z-axis are mutually orthogonal. The Y-axis is provided along the arm 42. Furthermore, the X-direction and the Y-direction are further defined herein. The X-direction is a direction along the X-axis, and includes the +X-direction indicated by the X-axis arrow and the-X-direction opposite the X-axis arrow. The Y-direction is a direction along the Y-axis, and includes the +Y-direction indicated by the Y-axis arrow and the-Y-direction opposite the Y-axis arrow.

The plurality of arms 42 protrude from the actuator block 41 in the +Y-direction. Thus, the Y-direction is the longitudinal direction of the arms 42. The X-direction is the lateral direction of the arms 42. The X-direction and the Y-direction vary as the carriage 35 rotates relative to the enclosure 11 around the axis Axh.

As illustrated in FIG. 2, the plurality of arms 42 are spaced apart in the Z-direction. Each of the arms 42 has a plate-like shape capable of entering the gap between adjacent magnetic disks 12. The plurality of arms 42 extend substantially in parallel with one another.

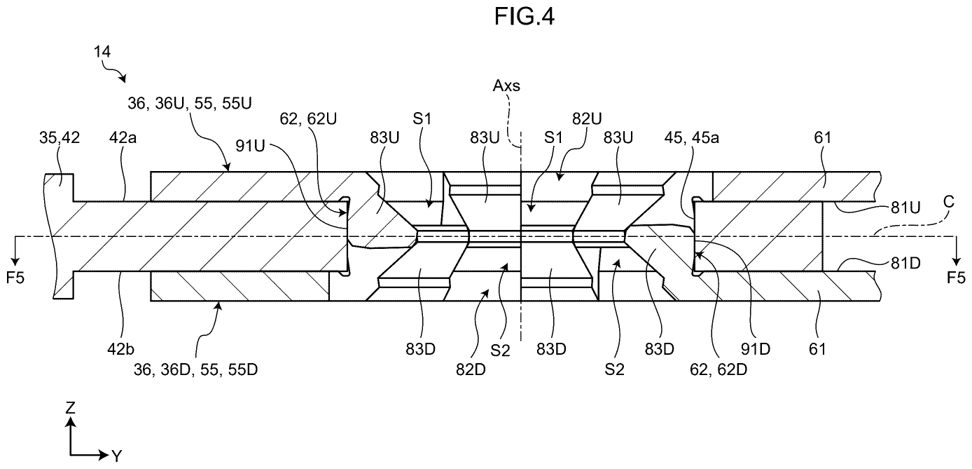

FIG. 4 is an exemplary cross-sectional view partially illustrating two HGAs 36 and an arm 42 according to the first embodiment along line F4-F4 in FIG. 3. As illustrated in FIG. 4, each of the plurality of arms 42 has two seating surfaces 42a and 42b.

The seating surfaces 42a and 42b are provided on the end portion of the arm 42 in the +Y-direction. The seating surface 42a is substantially flat and faces substantially in the +Z-direction. The seating surface 42b is opposite the seating surface 42a. The seating surface 42b is substantially flat and faces substantially in the −Z-direction.

Each of the plurality of arms 42 is provided with a caulking hole 45. The caulking hole 45 is one example of a first through-hole. The caulking hole 45 is a circular hole that penetrates the arm 42 substantially in the Z-direction so as to open to the seating surfaces 42a and 42b.

Each of the plurality of arms 42 further has an inner surface 45a that defines the caulking hole 45. The inner surface 45a is a substantially cylindrical curved surface extending along an axis Axs of the caulking hole 45. In the present embodiment, the diameter of the inner surface 45a is substantially constant.

The axis Axs is a virtual axis that extends substantially in the Z-direction. In other words, the axis Axh of rotation of the HSA 14 and the axis Axs of the caulking hole 45 are substantially parallel to each other. Additionally, the caulking holes 45 of the plurality of arms 42 are also aligned along the common axis Axs.

For convenience of description, herein, the axial direction, radial direction, and circumferential direction are further defined. The axial direction refers to the direction along the axis Axs. In the present embodiment, the axial direction substantially matches the Z-direction. The radial direction is a direction orthogonal to the axis Axs. The circumferential direction refers to a direction that encircles the axis Axs. The circumferential direction includes a first circumferential direction Dc1 and a second circumferential direction Dc2 illustrated in FIG. 3. The first circumferential direction Dc1 is one direction around the axis Axs. The second circumferential direction Dc2 is the direction opposite to the first circumferential direction Dc1.

Each of the plurality of HGAs 36 is attached to the seating surface 42a or the seating surface 42b so as to protrude from the arm 42 substantially in the +Y-direction. This allows the plurality of HGAs 36 to be arranged with spacing in the Z-direction.

As illustrated in FIG. 2, the plurality of HGAs 36 include a plurality of HGAs 36U and a plurality of HGAs 36D. The HGA 36U and the HGA 36D are substantially mirror-symmetric to each other, except for the points as specifically described below. In the following description, features common to the HGAs 36U and 36D are referred to collectively as features of the HGA 36.

Further, the two dummy masses 37 include a dummy mass 37U and a dummy mass 37D. The dummy mass 37U and the dummy mass 37D are formed in substantially mirror-symmetrical configurations, except as specifically described below.

Among the plurality of arms 42 that are aligned in the Z-direction, the HGA 36D and the dummy mass 37U are attached to the arm positioned at the end in the +Z-direction. Among the plurality of arms 42 that are aligned in the Z-direction, the HGA 36U and the dummy mass 37D are attached to the arm positioned at the end in the −Z-direction. The HGAs 36U and 36D are attached to the remaining ones of the plurality of arms 42. In other words, the multiple HGAs 36U and 36D are located between the two dummy masses 37U and 37D.

As illustrated in FIG. 4, each of the plurality of HGAs 36U is attached to the seating surface 42a of one of the plurality of arms 42. Each of the plurality of HGAs 36D is attached to the seating surface 42b of one of the plurality of arms 42.

As illustrated in FIG. 3, each of the plurality of HGAs 36 includes a magnetic head 51 and a suspension 52. The magnetic head 51 can also be referred to as a slider. The magnetic head 51 performs recording and reproduction of information on one of the plurality of magnetic disks 12. In other words, the magnetic head 51 reads and writes information from and to the magnetic disk 12.

The suspension 52 is attached to the arm 42 and holds the magnetic head 51. The suspension 52 includes a base plate 55, a load beam 56, and a flexure 57.

The base plate 55 and the load beam 56 are made of, for example, stainless steel. It is noted that the materials of the base plate 55 and the load beam 56 are not limited to this example and can be, for example, other metals. The base plate 55 and the load beam 56 can be made of mutually different materials.

As illustrated in FIG. 4, the base plate 55 includes a plate 61 and a boss 62. The plate 61 has a substantially rectangular shape and is disposed substantially orthogonally to the Z-direction. The boss 62 protrudes from the plate 61. The boss 62 has a substantially cylindrical shape extending along the axis Axs, and is fitted into the caulking hole 45 of the arm 42.

The boss 62 is caulked into the arm 42 to attach the base plate 55 to the arm 42 of the carriage 35. It is noted that the base plate 55 can also be attached to the arm 42 by any other suitable methods.

The load beam 56 has a plate-like shape that is thinner than the base plate 55. As illustrated in FIG. 3, the load beam 56 is attached to the plate 61 by, for example, spot welding. It is noted that the load beam 56 can be attached to the plate 61 by other means.

The load beam 56 extends generally from the plate 61 in the +Y-direction. For example, the load beam 56 extends obliquely from the plate 61 toward the corresponding magnetic disk 12.

The flexure 57 is a type of FPC of a long, thin strip shape. The flexure 57 includes, for example, a metallic backing layer, an insulating base layer, a conductive layer, and a cover layer as an insulating layer.

The flexure 57 extends along the arm 42, the load beam 56, and the plate 61. The flexure 57 is attached to the load beam 56 and the plate 61 by, for example, spot welding.

The end portion of the flexure 57 in the +Y-direction is provided with a gimbal 65. The magnetic head 51 is attached to the gimbal 65. The gimbal 65 holds the magnetic head 51 in a manner that allows oscillating movement of the magnetic head 51.

As illustrated in FIG. 1, one end portion of the FPC 38 is attached to the actuator block 41. The end portion of the flexure 57 in the −Y-direction is connected to the one end portion of the FPC 38. Thus, the flexure 57 electrically connects the magnetic head 51 and the FPC 38. The other end portion of the FPC 38 is connected, for example, to a connector provided on the bottom wall 25.

The carriage 35, the magnetic head 51, and the suspension 52 are housed in the enclosure 11. As illustrated in FIG. 2, each of the plurality of HGAs 36D is located closer to the bottom surface 25a than the corresponding HGA 36U attached to the common arm 42. Note that the arrangement of the HGAs 36U and 36D can be reversed.

As illustrated in FIG. 1, the VCM 15 includes a voice coil, a pair of yokes, and a magnet provided on the yokes. The voice coil is held by the actuator block 41. The VCM 15 rotates the carriage 35 around the axis Axh to move the magnetic head 51 to a desired position.

The movement of the magnetic head 51 to the outer edge of the magnetic disk 12 due to rotation of the HSA 14 by the VCM 15 causes the ramp load mechanism 16 to hold the magnetic head 51 at a position separated from the magnetic disk 12.

The PCB 17 is, for example, a rigid board such as a glass epoxy board, and is a multi-layer board or a build-up board. The PCB 17 is disposed outside the enclosure 11 and is attached to the bottom wall 25.

Various electronic components are mounted on the PCB 17, such as a relay connector 71 electrically connected to the FPC 38, an interface (I/F) connector 72 connected to a host computer, and a controller 73 that controls the operation of the HDD 10.

The relay connector 71 is electrically connected to the FPC 38 via a connector provided on the bottom wall 25. The controller 73 controls, for example, the spindle motor 13, the VCM 15, and the magnetic head 51.

As illustrated in FIG. 4, in the following description, the base plate 55 and the boss 62 of the HGA 36U are referred to as a base plate 55U and a boss 62U. The base plate 55U is an example of a first base plate. Furthermore, in the following description, the base plate 55 and the boss 62 of the HGA 36D are referred to as a base plate 55D and a boss 62D. The base plate 55D is an example of a second base plate. The arm 42 is located between the plate 61 of the base plate 55U and the plate 61 of the base plate 55D.

The plate 61 of the base plate 55U includes a flat surface 81U. The flat surface 81U is an example of a first surface. The flat surface 81U is substantially flat and faces substantially in the −Z-direction. The flat surface 81U faces and contacts with the seating surface 42a of the arm 42. It is noted that the flat surface 81U can be spaced apart from the seating surface 42a.

The plate 61 of the base plate 55U is provided with an insertion hole 82U. The insertion hole 82U is an example of a second through-hole. The insertion hole 82U is a circular opening that penetrates the plate 61 substantially in the Z-direction along the axis Axs. The insertion hole 82U communicates with the caulking hole 45 of the arm 42.

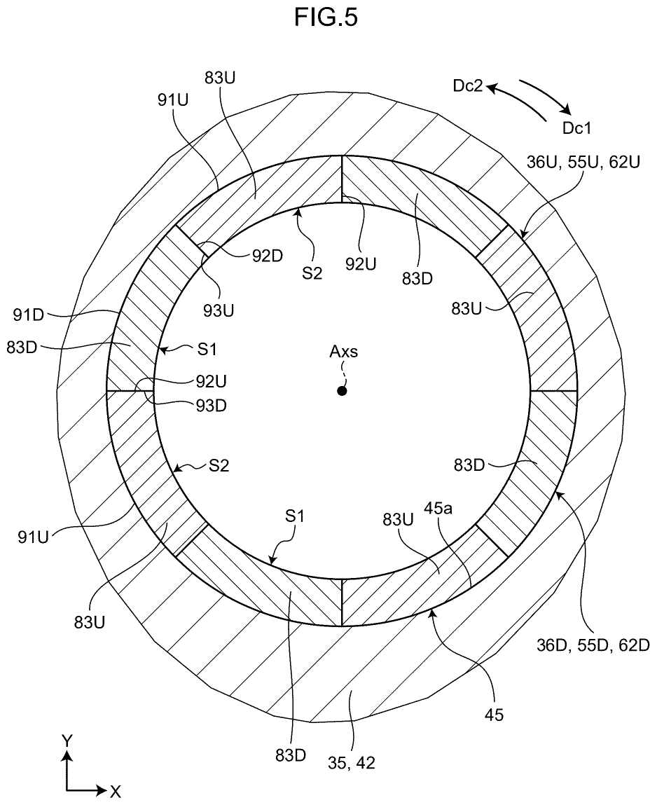

FIG. 5 is an exemplary cross-sectional view partially illustrating the arm 42 and the base plates 55U and 55D according to the first embodiment, taken along the line F5-F5 in FIG. 4. As illustrated in FIG. 5, the boss 62U is provided with two or more grooves S1 and divided into two or more protrusions 83U by the grooves S1. In other words, the boss 62U includes two or more protrusions 83U. In the present embodiment, the boss 62U is provided with four grooves S1 and four protrusions 83U. It is noted that the number of the grooves S1 and protrusions 83U is not limited to this example. The plurality of protrusions 83U are an example of a plurality of first protrusions.

As illustrated in FIG. 4, the plurality of protrusions 83U protrude from the flat surface 81U substantially in the-Z-direction. In the present embodiment, the plurality of protrusions 83U protrude from the edge of the insertion hole 82U in the flat surface 81U and are disposed around the insertion hole 82U with gaps (grooves S1). In other words, as illustrated in FIG. 5, the plurality of protrusions 83U are disposed in an annular form (endless form) around the axis Axs with gaps (grooves S1).

The insertion hole 82U, the plurality of grooves S1, and the plurality of protrusions 83U are arranged concentrically (coaxially) with the caulking hole 45. It is noted that the axes of the caulking hole 45, the insertion hole 82U, the plurality of grooves S1, and the plurality of protrusions 83U can be different from one another.

In the present embodiment, the groove S1 is provided, for example, between the end of the boss 62U in the −Z-direction and the flat surface 81U. In other words, in the axial direction, the length (depth) of the groove S1 is approximately equal to the length of the boss 62U. It is noted that the depth of the groove S1 is not limited to this example. For example, the boss 62U can include a connecting portion that connects two adjacent ones of the plurality of protrusions 83U. In such a case, the groove S1 is provided between the end of the boss 62U in the −Z-direction and the connecting portion.

The plurality of protrusions 83U are housed in the caulking hole 45 and are caulked against its inner surface 45a. In other words, the plurality of protrusions 83U are attached to the arm 42 by contact with the inner surface 45a. It is noted that the protrusions 83U can be attached to the arm 42 by any other suitable methods.

Each of the plurality of protrusions 83U has an outer peripheral surface 91U and two lateral surfaces 92U and 93U. The lateral surfaces 92U and 93U are an example of a first lateral surface. The outer peripheral surface 91U is a substantially arcuate curved surface extending in the circumferential direction. The outer peripheral surface 91U faces radially outward and contacts the inner surface 45a of the arm 42.

The lateral surface 92U is an end surface of the protrusion 83U in the first circumferential direction Dc1. The lateral surface 92U is substantially flat and faces the first circumferential direction Dc1. It is noted that the lateral surface 92U may not need to be flat as long as the lateral surface 92U generally faces the first circumferential direction Dc1.

The lateral surface 93U is an end surface of the protrusion 83U in the second circumferential direction Dc2. In other words, the lateral surface 93U is opposite to the lateral surface 92U. The lateral surface 93U is substantially flat and faces the second circumferential direction Dc2. It is noted that the lateral surface 93U may not need to be flat as long as the lateral surface 93U generally faces the second circumferential direction Dc2.

As illustrated in FIG. 4, the plate 61 of the base plate 55D has a flat surface 81D. The flat surface 81D is an example of a second surface. The flat surface 81D is substantially flat and faces substantially in the +Z-direction. The flat surface 81D faces and contacts the seating surface 42b of the arm 42. It is noted that the flat surface 81D can be spaced apart from the seating surface 42b.

The plate 61 of the base plate 55D is provided with an insertion hole 82D. The insertion hole 82D is an example of a third through-hole. The insertion hole 82D is a circular hole that penetrates the plate 61 substantially in the Z-direction along the axis Axs. The insertion hole 82D is in communication with the caulking hole 45 of the arm 42.

The boss 62D is provided with two or more grooves S2 and divided into two or more protrusions 83D by the grooves S2. In other words, the boss 62D includes two or more protrusions 83D. In the present embodiment, the boss 62D is provided with four grooves S2 and includes four protrusions 83D. It is noted that the number of grooves S2 and protrusions 83D is not limited to this example. The plurality of protrusions 83D are an example of a plurality of second protrusions.

The plurality of protrusions 83D protrude substantially in the +Z-direction from the flat surface 81D. In the present embodiment, the plurality of protrusions 83D protrude from the edge of the insertion hole 82D in the flat surface 81D and are disposed around the insertion hole 82D with gaps (grooves S2). In other words, as illustrated in FIG. 5, the plurality of protrusions 83D are disposed in an annular form with gaps (grooves S2) around the axis Axs.

The insertion hole 82D, the plurality of grooves S2, and the plurality of protrusions 83D are arranged concentrically with the caulking hole 45. It is noted that the central axes of the caulking hole 45, the insertion hole 82D, the plurality of grooves S2, and the plurality of protrusions 83D can be different from one another.

In the present embodiment, the groove S2 is provided, for example, between the end of the boss 62D in the +Z-direction and the flat surface 81D. In other words, in the axial direction, the length (depth) of the groove S2 is approximately equal to the length of the boss 62D. It is noted that the depth of the groove S2 is not limited to this example. For example, the boss 62D can include a connecting portion that connects two adjacent ones of the plurality of protrusions 83D. In such a case, the groove S2 is provided between the end of the boss 62D in the +Z-direction and the connecting portion.

The plurality of protrusions 83D are housed in the caulking holes 45 and are caulked against the inner surface 45a. In other words, the plurality of protrusions 83D are attached to the arm 42 by contact with the inner surface 45a. It is noted that the protrusions 83D can be attached to the arm 42 by other suitable methods.

Each of the plurality of protrusions 83D has an outer peripheral surface 91D and two lateral surfaces 92D and 93D. The lateral surfaces 92D and 93D are examples of a second lateral surface. The outer peripheral surface 91D is a substantially arcuate curved surface extending in the circumferential direction. The outer peripheral surface 91D faces radially outward and comes into contact with the inner surface 45a of the arm 42.

The lateral surface 92D is an end surface of the protrusion 83D in the first circumferential direction Dc1. The lateral surface 92D is substantially flat and faces the first circumferential direction Dc1. It is noted that the lateral surface 92D may not need to be flat as long as it generally faces in the first circumferential direction Dc1.

The lateral surface 93D is an end surface of the protrusion 83D in the second circumferential direction Dc2. In other words, the lateral surface 93D is opposite the lateral surface 92D. It is noted that the lateral surface 93D is substantially flat and faces the second circumferential direction Dc2. The lateral surface 93D may not need to be flat as long as it generally faces in the second circumferential direction Dc2.

In the circumferential direction, the positions of the plurality of protrusions 83U and the positions of the plurality of protrusions 83D are different from each other. Additionally, in the circumferential direction, the positions of the plurality of grooves S1 and the positions of the plurality of grooves S2 are also different from each other. For example, the positions of the plurality of protrusions 83U and the plurality of grooves S1 and the positions of the plurality of protrusions 83D and the plurality of grooves S2 are arranged in mirror symmetry. In such a case, the base plates 55U and 55D can be standardized (i.e., made common). It is noted that the positions of the protrusions 83U and 83D and the grooves S1 and S2 are not limited to this example.

The plurality of protrusions 83U are fitted into the corresponding grooves S2. The plurality of protrusions 83D are fitted into the corresponding grooves S1. In other words, the plurality of protrusions 83U are disposed such that at least one of the plurality of protrusions 83D is located between two adjacent ones of the plurality of protrusions 83U. Likewise, the plurality of protrusions 83D are disposed such that at least one of the plurality of protrusions 83U is located between two adjacent ones of the plurality of protrusions 83D.

In the present embodiment, the plurality of protrusions 83U and the plurality of protrusions 83D are disposed alternately around the axis Axs. It is noted that two or more protrusions 83U can be fitted into one groove S2, and two or more protrusions 83D can be fitted into one groove S1.

As illustrated in FIG. 4, in the axial direction, the length of the protrusion 83U is equal to or more than half the length of the caulking hole 45 and is equal to or less than the length of the caulking hole 45. It is noted that the length of the protrusion 83U is not limited to this example, and can be shorter than half the length of the caulking hole 45 or greater than the length of the caulking hole 45.

In the axial direction, the length of the protrusion 83D is equal to or more than half the length of the caulking hole 45 and is equal to or less than the length of the caulking hole 45. It is noted that the length of the protrusion 83D is not limited to this example, and can be shorter than half the length of the caulking hole 45 or greater than the length of the caulking hole 45.

Since the length of the protrusions 83U and 83D is equal to or more than half the length of the caulking hole 45, the plurality of protrusions 83U and the plurality of protrusions 83D overlap with each other in the circumferential direction at the center C of the caulking hole 45 in the axial direction. In FIG. 4, the center C is schematically indicated by a chain double-dashed line. It is noted that the center C also represents the center of the inner surface 45a in the axial direction.

The plurality of protrusions 83U are in contact with the inner surface 45a of the arm 42 at the center C or at a position closer to the flat surface 81D than to the center C. The plurality of protrusions 83D are in contact with the inner surface 45a at the center C or at a position closer to the flat surface 81U than to the center C.

As illustrated in FIG. 5, every one of the plurality of protrusions 83U is in contact with the two respective adjacent protrusions of the plurality of protrusions 83D. In the present embodiment, the lateral surface 92U of the protrusion 83U contacts the lateral surface 93D of one of the protrusions 83D while the lateral surface 93U of the protrusion 83U contacts the lateral surface 92D of another one of the protrusions 83D.

Every one of the plurality of protrusions 83D are in contact with the two respective adjacent ones of the plurality of protrusions 83U. In the present embodiment, the lateral surface 92D of the protrusion 83D contacts the lateral surface 93U of one of the protrusions 83U, and the lateral surface 93D of the protrusion 83D contacts the lateral surface 92U of another of the protrusions 83U.

The plurality of protrusions 83U and 83D are juxtaposed to each other around the axis Axs to push against each other in the circumferential direction. Each of the plurality of protrusions 83U is held between two adjacent ones of the plurality of protrusions 83D. Further, each of the plurality of protrusions 83D is held between two adjacent ones of the plurality of protrusions 83U. In this way, by the mutual contact between the plurality of protrusions 83U and the plurality of protrusions 83D, the base plate 55U and the base plate 55D can be attached to each other. In other words, the plurality of protrusions 83U and 83D are caulked to one another and to the arm 42.

As illustrated in FIG. 2, the dummy mass 37U includes a base plate 55U. The base plate 55U of the dummy mass 37U is identical to the base plate 55U of the HGA 36U. It is noted that the dummy mass 37U can further include other components such as the load beam 56.

The dummy mass 37D includes the base plate 55D. The base plate 55D of the dummy mass 37D is identical to the base plate 55D of the HGA 36D. It is noted that the dummy mass 37D can further include other components such as the load beam 56.

An example of a method of caulking the base plates 55U and 55D, which constitutes part of the manufacturing process of the HDD 10, is now described. It is noted that the method of caulking the base plates 55U and 55D is not limited to the following method and can be implemented by other methods.

The boss 62U of the base plate 55U and the boss 62D of the base plate 55D are first inserted into the caulking hole 45 of the arm 42. As a result, the plurality of protrusions 83U are inserted into the plurality of grooves S2, and the plurality of protrusions 83D are inserted into the plurality of grooves S1.

Before caulking, the diameter of the outer peripheral surface 91U of the plurality of protrusions 83U is smaller than the diameter of the inner surface 45a of the arm 42. Additionally, before caulking, the diameter of the outer peripheral surface 91D of the plurality of protrusions 83D is smaller than the diameter of the inner surface 45a. Thus, before caulking, at least a portion of each of the bosses 62U and 62D is spaced apart from the inner surface 45a.

In addition, before caulking, the distance between two adjacent ones of the plurality of protrusions 83U in the circumferential direction is greater than the length of each of the plurality of protrusions 83D in the circumferential direction. Thus, before caulking, each of the plurality of protrusions 83D is spaced apart from at least one of the two adjacent ones of the plurality of protrusions 83U.

Before caulking, the distance between two adjacent ones of the plurality of protrusions 83D in the circumferential direction is greater than the length of each of the plurality of protrusions 83U in the circumferential direction. Thus, before caulking, each of the plurality of protrusions 83U is spaced apart from at least one of the two adjacent ones of the plurality of protrusions 83D.

Then, a ball passes through the caulking hole 45 and the insertion holes 82U and 82D. The ball is constructed from, for example, stainless steel. The rigidity of the ball is higher than the rigidity of the plurality of protrusions 83U and also higher than the rigidity of the plurality of protrusions 83D.

The ball passes through the insertion hole 82U and enters the caulking hole 45. The ball pushes the plurality of protrusions 83U and 83D radially outward. As a result, each of the plurality of protrusions 83U undergoes plastic deformation such that it comes into contact with the inner surface 45a of the arm 42 and contacts two adjacent ones of the plurality of protrusions 83D. Additionally, each of the plurality of protrusions 83D undergoes plastic deformation such that it comes into contact with the inner surface 45a and contacts two adjacent ones of the plurality of protrusions 83U. As a result, the arm 42, the base plate 55U, and the base plate 55D are joined to one another. The ball passes through the insertion hole 82D and then exits the caulking hole 45.

In the first embodiment described above, the HDD 10 includes the plurality of magnetic disks 12, the HGA 36U, the base plate 55D, and the carriage 35. The HGA 36U includes the magnetic head 51 configured to read and write information from and to one of the plurality of magnetic disks 12, and the base plate 55U. The carriage 35 is rotatable and includes the arm 42 located between the two base plates 55U and 55D. The arm 42 is provided with the caulking hole 45 and has the inner surface 45a defining the caulking hole 45. The base plate 55U includes the flat surface 81U and the plurality of protrusions 83U. The flat surface 81U faces the arm 42. The plurality of protrusions 83U protruding from the flat surface 81U are attached to the arm 42 by contact with the inner surface 45a of the arm 42. The base plate 55D includes the flat surface 81D and the plurality of protrusions 83D. The flat surface 81D faces the arm 42. The plurality of protrusions 83D protruding from the flat surface 81D are attached to the arm 42 by contact with the inner surface 45a of the arm 42. The plurality of protrusions 83U are disposed such that at least one of the plurality of protrusions 83D is located between two adjacent ones of the plurality of protrusions 83U. The plurality of protrusions 83D are disposed such that at least one of the plurality of protrusions 83U is located between two adjacent ones of the plurality of protrusions 83D. By the mutual contact between the plurality of protrusions 83U and the plurality of protrusions 83D, the base plate 55U and the base plate 55D are attached to each other.

Each of the plurality of protrusions 83U is located between two corresponding adjacent protrusions 83D to be able to contact the inner surface 45a of the arm 42. Each of the plurality of protrusions 83D is located between two corresponding adjacent protrusions 83U to be able to contact the inner surface 45a of the arm 42. Thus, the arm 42 can accommodate the plurality of protrusions 83U and the plurality of protrusions 83D in the same part (e.g., around the center C) of the caulking hole 45. Thereby, the arm 42 can be decreased in thickness. As such, the HDD 10 can allow the plurality of magnetic disks 12 to be arranged with a smaller gap, enabling a larger number of magnetic disks 12 to be mounted thereon. The increase in the number of magnetic disks 12 can increase the storage capacity of the HDD 10.

Further, the HDD 10 can allow the arm 42, the base plate 55U, and the base plate 55D to be more firmly joined together, as compared with an HDD 10 with the plurality of protrusions 83U and the plurality of protrusions 83D spaced apart from each other. In this manner the HDD 10 enables more secure attachment of the base plate 55U and the base plate 55D to the arm 42. According to the HDD 10, thus, the base plates 55U and 55D are less likely or unlikely to be detached from the arm 42, in the event of receiving an impact or during a high-speed rotation of the carriage 35, for example.

The plurality of protrusions 83U are disposed around the axis Axs of the caulking hole 45. The plurality of protrusions 83D are also disposed around the axis Axs. In other words, the plurality of protrusions 83U and the plurality of protrusions 83D are disposed in an annular (endless) form. As a result, every protrusion 83U can contact the respective neighboring protrusions 83D. Thus, the HDD 10 can provide a greater contact area between the protrusions 83U and 83D, as compared with a linear disposal of the protrusions 83U and 83D. This leads to enhancing the joint strength among the arm 42, the base plate 55U, and the base plate 55D.

Each of the plurality of protrusions 83U has a lateral surface 92U oriented in the circumferential direction around the axis Axs and contacting one of the plurality of protrusions 83D. Each of the plurality of protrusions 83D has a lateral surface 92D oriented in the circumferential direction and contacting one of the plurality of protrusions 83U. This causes a circumferential force between every two adjacent protrusions 83U and 83D. In this manner, the HDD 10 can allow the plurality of protrusions 83U and the plurality of protrusions 83D to be more firmly joined together.

The plurality of protrusions 83U contact with the inner surface 45a of the arm 42 at the axial center C of the inner surface 45a along the axis Axs or at a position closer to the flat surface 81D than to the axial center C. The plurality of protrusions 83D contact with the inner surface 45a of the arm 42 at the axial center C of the inner surface 45a or at a position closer to the flat surface 81U than to the axial center C. Thereby, the plurality of protrusions 83U and the plurality of protrusions 83D can overlap each other around the axis Axs. As such, the HDD 10 can allow the plurality of protrusions 83U and the plurality of protrusions 83D to be more firmly joined together.

The base plate 55U is provided with the insertion hole 82U communicating with the caulking hole 45. The plurality of protrusions 83U are disposed around the insertion hole 82U. The base plate 55D is provided with the insertion hole 82D communicating with the caulking hole 45. The plurality of protrusions 83D are disposed around the insertion hole 82D. In other words, the plurality of protrusions 83U and the plurality of protrusions 83D are disposed in an annular (endless) form. As a result, every protrusion 83U can contact the respective neighboring protrusions 83D. In this manner, as compared with a linear disposal of the protrusions 83U and 83D, the HDD 10 can provide a greater contact area between the protrusions 83U and 83D, thereby enhancing the joint strength among the arm 42, the base plate 55U, and the base plate 55D.

The plurality of protrusions 83U and the plurality of protrusions 83D are disposed alternately. Every one of the plurality of protrusions 83U is in contact with the two corresponding adjacent ones of the plurality of protrusions 83D. Thus, as compared with a disposal of two or more protrusions 83U in-between two adjacent protrusions 83D, the HDD 10 can provide a greater contact area between the plurality of protrusions 83U and the plurality of protrusions 83D, thereby enhancing the joint strength among the arm 42, the base plate 55U, and the base plate 55D.

The plurality of magnetic disks 12 includes twelve or more magnetic disks 12. There are restrictions on the dimensions of the HDD 10, for example, by form-factor standards. For example, in the technical field of HDD, the Small Form Factor Committee has established SFF-8300 as a form factor for 3.5-inch HDDs. SFF-8300 specifies multiple maximum dimensions for the HDD. According to SFF-8300, the magnetic disks 12 are to be arranged with a smaller gap in an HDD 10 incorporating twelve or more magnetic disks 12. According to the HDD 10 of the present embodiment, however, the arm 42 can be decreased in thickness to be able to enter such a smaller gap.

### Second Embodiment

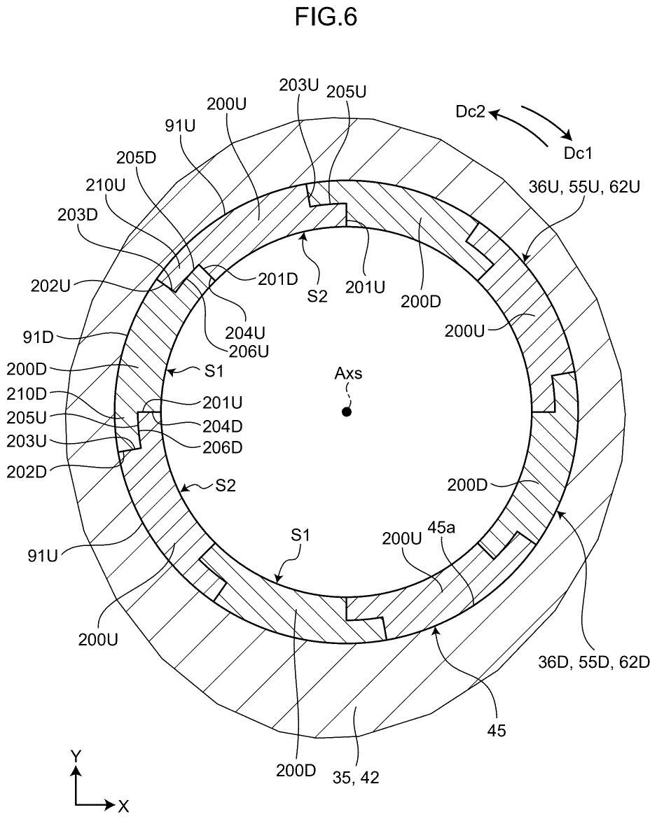

A second embodiment is now described with reference to FIG. 6. It is noted that, In the description of the following embodiments, components having functions similar to those already described are given the same reference numerals as the components already described, and redundant description may be omitted. In addition, the components given the same reference numerals do not necessarily share all the same functions and properties, and may exhibit different functions and properties depending on each embodiment.

FIG. 6 is an exemplary cross-sectional view partially illustrating an arm 42 and base plates 55U and 55D according to the second embodiment. As illustrated in FIG. 6, bosses 62U and 62D according to the second embodiment include a plurality of protrusions 200U and 200D, instead of the multiple protrusions 83U and 83D. The protrusions 200U and 200D are substantially the same as the protrusions 83U, 83D, except as described below.

In place of the lateral surfaces 92U and 93U, the protrusion 200U has end surfaces 201U and 202U, lateral surfaces 203U and 204U, an outer surface 205U, and an inner surface 206U. The end surface 201U is an example of a first end surface. The lateral surface 203U is an example of a first lateral surface. The outer surface 205U is an example of a first outer surface.

The end surface 201U is an end surface of the protrusion 200U in a first circumferential direction Dc1. The end surface 201U is substantially flat and faces in the first circumferential direction Dc1. The end surface 202U is an end surface of the protrusion 200U in a second circumferential direction Dc2. The end surface 202U is substantially flat and faces in the second circumferential direction Dc2.

The lateral surface 203U is located closer to the inner surface 45a of the arm 42 than the end surface 201U and is spaced from the end surface 201U in the second circumferential direction Dc2. The lateral surface 203U is substantially flat and faces in the first circumferential direction Dc1. It is noted that the end surface 201U and the lateral surface 203U may not need to be flat as long as they generally face in the first circumferential direction Dc1.

The lateral surface 204U is located farther from the inner surface 45a of the arm 42 than the end surface 202U and is spaced from the end surface 202U in the first circumferential direction Dc1. The lateral surface 204U is substantially flat and faces in the second circumferential direction Dc2. It is noted that the end surface 202U may not need to be flat as long as it generally faces in the second circumferential direction Dc2.

The outer surface 205U is located between the radially outer end of the end surface 201U and the radially inner end of the lateral surface 203U. The outer surface 205U is a curved surface extending around the axis Axs and faces radially outward. In other words, the outer surface 205U faces the inner surface 45a of the arm 42.

The inner surface 206U is provided between an end of the end surface 202U on the radially inner side and an end of the lateral surface 204U on the radially outer side. The inner surface 206U is a curved surface extending around the axis Axs and faces radially inward. The inner surface 206U is opposite to the outer circumferential surface 91U.

In place of the lateral surfaces 92D and 93D, the protrusion 200D has end surfaces 201D and 202D, lateral surfaces 203D and 204D, an outer surface 205D, and an inner surface 206D. The end surface 201D is an example of a second end surface. The lateral surface 203D is an example of a second lateral surface. The outer surface 205D is an example of a second outer surface.

The end surface 201D is an end surface of the protrusion 200D in the first circumferential direction Dc1. The end surface 201D is substantially flat and faces in the first circumferential direction Dc1. The end surface 202D is an end surface of the protrusion 200D in the second circumferential direction Dc2. The end surface 202D is substantially flat and faces in the second circumferential direction Dc2.

The lateral surface 203D is located closer to the inner surface 45a of the arm 42 than the end surface 201D and is spaced from the end surface 201D in the second circumferential direction Dc2. The lateral surface 203D is substantially flat and faces in the first circumferential direction Dc1. It is noted that the end surface 201D and the lateral surface 203D may not need to be flat as long as they generally face in the first circumferential direction Dc1.

The lateral surface 204D is located farther from the inner surface 45a of the arm 42 than the end surface 202D and is spaced from the end surface 202D in the first circumferential direction Dc1. The lateral surface 204D is substantially flat and faces in the second circumferential direction Dc2. The end surface 202D may not need to be flat as long as it generally faces in the second circumferential direction Dc2.

The outer surface 205D is located between the radially outer end of the end surface 201D and the radially inner end of the lateral surface 203D. The outer surface 205D is a curved surface extending around the axis Axs and faces radially outward. In other words, the outer surface 205D faces the inner surface 45a of the arm 42.

The inner surface 206D is provided between an end of the end surface 202D on the radially inner side and an end of the lateral surface 204D on the radially outer side. The inner surface 206D is a curved surface extending around the axis Axs and faces radially inward. The inner surface 206D is opposite to the outer circumferential surface 91D.

The end surface 201U and the lateral surface 204D are in contact with each other. The end surface 202U and the lateral surface 203D are in contact with each other. The lateral surface 203U and the end surface 202D are in contact with each other. The lateral surface 204U and the end surface 201D are in contact with each other. As a result, the plurality of protrusions 200U and 200D press against each other in the circumferential direction.

A part 210U of the protrusion 200U between the outer circumferential surface 91U and the inner surface 206U is located between the outer surface 205D of the protrusion 200D and the inner surface 45a of the arm 42. The inner surface 206U and the outer surface 205D are in contact with each other. The protrusion 200D thus presses the part 210U against the inner surface 45a.

The protrusion 200D has a part 210D, which is located between the outer peripheral surface 91D and the inner surface 206D of the protrusion 200D and is disposed between the outer surface 205U of the protrusion 200U and the inner surface 45a of the arm 42. The outer surface 205U and the inner surface 206D are in contact with each other. The protrusion 200U presses the part 210D against the inner surface 45a.

As described above, the protrusion 200U is in contact with the protrusion 200D via at least one of an end surface 201U, a lateral surface 203U, and an outer surface 205U. It is noted that at least two of the end surface 201U, the lateral surface 203U, and the outer surface 205U can be spaced apart from the protrusion 200D.

The protrusion 200D is in contact with the protrusion 200U via at least one of the end surface 201D, the lateral surface 203D, and the outer surface 205D. It is noted that at least two of the end surface 201D, lateral surface 203D, and outer surface 205D can be spaced apart from the protrusion 200U.

In the HDD 10 according to the second embodiment described above, each of the plurality of protrusions 200U has the end surface 201U in the circumferential direction around the axis Axs, the lateral surface 203U oriented in the circumferential direction, and the outer surface 205U located between the end surface 201U and the lateral surface 203U and facing the inner surface 45a of the arm 42. At least one of the end surface 201U, the lateral surface 203U, and the outer surface 205U of each of the plurality of protrusions 200U is in contact with one of the plurality of protrusions 200D. Each of the plurality of protrusions 200D has the end surface 201D in the circumferential direction, the lateral surface 203D oriented in the circumferential direction, and the outer surface 205D located between the end surface 201D and the lateral surface 203D and facing the inner surface 45a of the arm 42. At least one of the end surface 201D, the lateral surface 203D, and the outer surface 205D of each of the plurality of protrusions 200D is in contact with one of the plurality of protrusions 200U. This contact causes at least one of a circumferential force and a radial force between the adjacent protrusions 200U and protrusions 200D. In the HDD 10, the circumferential force can work to strengthen the joint between the plurality of protrusions 200U and the plurality of protrusions 200D. Further, in the HDD 10, the radial force causes one of the adjacent protrusions 200U and 200D to press the other against the inner surface 45a of the arm 42, thereby strengthening the joint among the arm 42, the base plate 55U, and the base plate 55D.

Each of the plurality of protrusions 200U is partially located between the outer surface 205D and the inner surface 45a of the arm 42 such that at least the outer surface 205U of each protrusion 200U contacts one of the plurality of protrusions 200D. Each of the plurality of protrusions 200D is partially located between the outer surface 205U and the inner surface 45a of the arm 42 such that at least the outer surface 205D of each protrusion 200D contacts one of the plurality of protrusions 200U. This contact causes a radial force between the adjacent protrusions 200U and 200D. In the HDD 10, the radial force also causes one of the adjacent protrusions 200U and 200D to press the other against the inner surface 45a of the arm 42, thereby strengthening the joint among the arm 42, the base plate 55U, and the base plate 55D.

### Third Embodiment

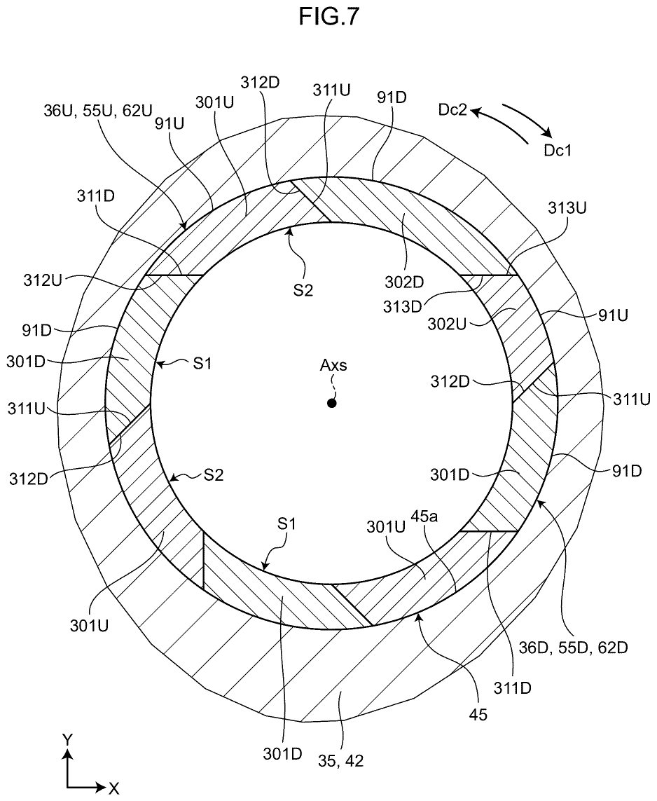

A third embodiment is now described with reference to FIG. 7. FIG. 7 is an exemplary cross-sectional view partially illustrating an arm 42 and base plates 55U and 55D according to the third embodiment. As illustrated in FIG. 7, a boss 62U according to the third embodiment includes a plurality of protrusions 301U and one protrusion 302U, instead of the plurality of protrusions 83U. The protrusions 301U and 302U are substantially identical to the protrusion 83U, except for the points described below. It is noted that the boss 62U can include only the plurality of protrusions 301U without including the protrusion 302U.

Each of the plurality of protrusions 301U includes inclined surfaces 311U and 312U, instead of the lateral surfaces 92U and 93U. The inclined surface 311U is an example of a first inclined surface.

The inclined surface 311U is an end surface of the protrusion 301U in the first circumferential direction Dc1. The inclined surface 311U is substantially flat and faces an oblique direction between the first circumferential direction Dc1 and the radially outward direction. It is noted that the inclined surface 311U may not need to be flat as long as it generally faces in the oblique direction.

The inclined surface 312U is an end surface of the protrusion 301U in the second circumferential direction Dc2. The inclined surface 312U is substantially flat and faces in an oblique direction between the second circumferential direction Dc2 and the radially inward direction. It is noted that the inclined surface 312U may not need to be flat as long as it generally faces in the oblique direction.

The protrusion 302U includes inclined surfaces 311U and 313U, instead of the lateral surfaces 92U and 93U. The inclined surface 311U of the protrusion 302U is substantially equal to the inclined surface 311U of the protrusion 301U. The inclined surface 313U is an end surface of the protrusion 302U in the second circumferential direction Dc2. The inclined surface 313U is substantially flat and faces in an oblique direction between the second circumferential direction Dc2 and the radially outer side. It is noted that the inclined surface 313U may not need to be flat as long as it generally faces the oblique direction.

Each of the plurality of protrusions 301D has inclined surfaces 311D and 312D, instead of the lateral surfaces 92D and 93D. The inclined surface 311D is an example of a second inclined surface.

The inclined surface 311D is an end surface of the protrusion 301D in the first circumferential direction Dc1. The inclined surface 311D is substantially flat and faces an oblique direction between the first circumferential direction Dc1 and the radially outward direction. It is noted that the inclined surface 311D may not need to be flat as long as it generally faces the oblique direction.

The inclined surface 312D is an end surface of the protrusion 301D in the second circumferential direction Dc2. The inclined surface 312D is substantially flat and faces in an oblique direction between the second circumferential direction Dc2 and the radially inward direction. It is noted that the inclined surface 312D may not need to be flat as long as it generally faces in the oblique direction.

The protrusion 302D has inclined surfaces 313D and 312D, instead of the lateral surfaces 92D and 93D. The inclined surface 312D of the protrusion 302D is substantially equal to the inclined surface 312D of the protrusion 301D. The inclined surface 313D is an end surface of the protrusion 302D in the first circumferential direction Dc1. The inclined surface 313D is substantially flat and faces in an oblique direction between the second circumferential direction Dc2 and the inner side in the radial direction. It is noted that the inclined surface 313D may not need to be flat as long as it generally faces in the oblique direction.

One of the inclined surfaces 311U of the plurality of protrusions 301U and the inclined surface 312D of the protrusion 302D are in contact with each other. One of the inclined surfaces 312D of the plurality of protrusions 301D and the inclined surface 311U of the protrusion 302U are in contact with each other. The inclined surface 313U of the protrusion 302U and the inclined surface 313D of the protrusion 302D are in contact with each other.

The rest of the inclined surfaces 311U of the plurality of protrusions 301U are in contact with the rest of the inclined surfaces 312D of the plurality of protrusions 301D. The rest of the inclined surfaces 312U of the plurality of protrusions 301U are in contact with the rest of the inclined surfaces 311D of the plurality of protrusions 301D.

The inclined surfaces 311U of the plurality of protrusions 301U and 302U press on the plurality of protrusions 301D and 302D in the circumferential direction and also press them against the inner surface 45a of the arm 42. The inclined surfaces 311D of the plurality of protrusions 301D press on the plurality of protrusions 301U in the circumferential direction and also press them against the inner surface 45a of the arm 42.

In the case where the bosses 62U and 62D are caulked into the caulking holes 45, the inclined surfaces 311U have a possibility of pressing the protrusions 301D and 302D in the first circumferential direction Dc1. Additionally, the inclined surface 311D has a possibility of pressing the protrusion 301U in the first circumferential direction Dc1. However, the inclined surface 313U of the protrusion 302U presses the protrusion 302D in the second circumferential direction Dc2. Thus, it is possible to suppress rotation of the base plates 55U and 55D relative to the arm in the first circumferential direction Dc1.

In the HDD 10 according to the third embodiment described above, each of the plurality of protrusions 301U has the inclined surface 311U. The inclined surface 311U faces a direction between outside the radial direction orthogonal to the axis Axs and the circumferential direction around the axis Axs, and is in contact with one of the plurality of protrusions 301D. Each of the plurality of protrusions 301D has the inclined surface 311D. The inclined surface 311D faces a direction between outside the radial direction and the circumferential direction, and is in contact with one of the plurality of protrusions 301U. Thus, each protrusion 301U presses the corresponding protrusion 301D against the inner surface 45a of the arm 42 in the circumferential direction. Likewise, each protrusion 301D presses the corresponding protrusion 301U against the inner surface 45a of the arm 42 in the circumferential direction. In this manner, the HDD 10 can allow the arm 42, the base plate 55U, and the base plate 55D to be more firmly joined together.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a plurality of magnetic disks;
a head gimbal assembly including a magnetic head and a first base plate, the magnetic head being configured to read and write information from and to one of the plurality of magnetic disks;
a second base plate;
and a rotatable carriage including an arm located between the first base plate and the second base plate, wherein
the arm is provided with a first through-hole and includes an inner surface defining the first through-hole,
the first base plate includes
a first surface facing the arm,
and a plurality of first protrusions protruding from the first surface, each of which is attached to the arm by contact with the inner surface of the arm,
the second base plate includes
a second surface facing the arm,
and a plurality of second protrusions protruding from the second surface, each of which is attached to the arm by contact with the inner surface of the arm,
the plurality of first protrusions are disposed such that at least one of the plurality of second protrusions is located between two adjacent first protrusions of the plurality of first protrusions,
the plurality of second protrusions are disposed such that at least one of the plurality of first protrusions is located between two adjacent second protrusions of the plurality of second protrusions,
and the first base plate and the second base plate are attached to each other by mutual contact between the plurality of first protrusions and the plurality of second protrusions.

2. The disk device according to claim 1, wherein
the plurality of first protrusions are disposed around an axis of the first through-hole,
and the plurality of second protrusions are disposed around the axis.

3. The disk device according to claim 2, wherein
each of the plurality of first protrusions includes a first lateral surface oriented in a circumferential direction around the axis and contacting one of the plurality of second protrusions,
and each of the plurality of second protrusions includes a second lateral surface oriented in the circumferential direction and contacting one of the plurality of first protrusions.

4. The disk device according to claim 2, wherein
each of the plurality of first protrusions includes
a first end surface in a circumferential direction around the axis,
a first lateral surface oriented in the circumferential direction,
and a first outer surface located between the first end surface and the first lateral surface and facing the inner surface,
at least one of the first end surface, the first lateral surface, and the first outer surface of each of the plurality of first protrusions contacts one of the plurality of second protrusions,
each of the plurality of second protrusions includes
a second end surface in the circumferential direction,
a second lateral surface oriented in the circumferential direction,
and a second outer surface located between the second end surface and the second lateral surface and facing the inner surface,
and at least one of the second end surface, the second lateral surface, and the second outer surface of each of the plurality of second protrusions contacts one of the plurality of first protrusions.

5. The disk device according to claim 4, wherein
each of the plurality of first protrusions is partially located between the second outer surface and the inner surface of the arm, such that at least the first outer surface contacts one of the plurality of second protrusions,
and each of the plurality of second protrusions is partially located between the first outer surface and the inner surface of the arm, such that at least the second outer surface contacts one of the plurality of first protrusions.

6. The disk device according to claim 2, wherein
each of the plurality of first protrusions includes a first inclined surface oriented in a direction between outside a radial direction orthogonal to the axis and a circumferential direction around the axis, and contacting one of the plurality of second protrusions,
and each of the plurality of second protrusions includes a second inclined surface oriented in a direction between outside the radial direction and the circumferential direction, and contacting one of the plurality of first protrusions.

7. The disk device according to claim 2, wherein
each of the plurality of first protrusions contacts the inner surface of the arm at an axial center of the inner surface along the axis or at a position closer to the second surface than to the axial center,
and each of the plurality of second protrusions contacts the inner surface of the arm at the axial center of the inner surface or at a position closer to the first surface than to the axial center.

8. The disk device according to claim 1, wherein
the first base plate is provided with a second through-hole communicating with the first through-hole,
the plurality of first protrusions are disposed around the second through-hole,
the second base plate is provided with a third through-hole communicating with the first through-hole,
and the plurality of second protrusions are disposed around the third through-hole.

9. The disk device according to claim 1, wherein
the plurality of first protrusions and the plurality of second protrusions are alternately disposed,
and each of the plurality of first protrusions is in contact with two corresponding adjacent ones of the plurality of second protrusions.

10. The disk device according to claim 1, wherein
the plurality of magnetic disks includes twelve or more magnetic disks.
